(19) United States
(12) Patent Application Publication
(10) Pub. No.: US 2024/0428500 A1
(43) Pub. Date: Dec. 26, 2024

(54) High Fidelity Canonical Texture Mapping from Single-View Images

(71) Applicant: Google LLC, Mountain View, CA (US)

(72) Inventors: Tanmay Shah, San Ramon, CA (US); Vishal Vinod, San Diego, CA (US); Dmitry Lagun, San Jose, CA (US)

(21) Appl. No.: 18/338,060

(22) Filed: Jun. 20, 2023

(51) Int. Cl. G06T 15/04; G06T 7/70; G06T 17/00

(52) U.S. Cl. CPC G06T 15/04; G06T 7/70; G06T 17/005; G06T 2207/20081; G06T 2207/20084; G06T 2207/30244

(57) ABSTRACT

Provided are systems and methods for creating 3D representations from one or more images of objects. It involves training a machine-learned correspondence network to convert 3D locations of pixels into a 2D canonical coordinate space. This network can map texture values from ground truth or synthetic images of the object into the 2D space, creating a texture data set. When a new synthetic image is generated from a specific pose, the 3D locations can be mapped into the 2D space, allowing texture values to be retrieved and applied to the new image. The system also enables users to edit the texture data, facilitating texture edits and transfers across objects.

### FIELD

The present disclosure relates generally to image synthesis. More particularly, the present disclosure relates to high fidelity canonical texture mapping from single-view images.

### BACKGROUND

Reconstructing high-resolution and high-fidelity 3D consistent representations from single-view in-the-wild image collections is valuable in various applications such as virtual reality, 3D content creation and telepresence systems.

Recent works in Neural Radiance Fields (NeRFs) aim to address this task by leveraging the inductive bias across a dataset of single-view images of class-specific objects for 3D consistent rendering. However, these works are unable to preserve high frequency details while reconstructing the input data despite the use of various supporting techniques. This inability to preserve details is in part due to the properties of the multi-layer perceptrons (MLPs) that are used in the corresponding models. Further, for arbitrary resolution 3D reconstruction from single-view images, these methods face several challenges such as image-space approximations that break multi-view consistency constraining the rendering resolution, requiring Pivotal Tuning Inversion (PTI) or fine-tuning for reconstruction and the inability to preserve high-frequency details.

Thus, while recent work in Neural Fields (NFs) learn 3D representations from class-specific single view image collections, they are unable to reconstruct the input data preserving high-frequency details. Further, these methods do not disentangle appearance or texture from geometry and hence are not suitable for tasks such as texture transfer and editing.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method to perform image synthesis. The method includes obtaining, by a computing system comprising one or more computing devices, data descriptive of a pose from which to render a synthetic image of an object. The method includes generating, by the computing system using an image generation model, a three-dimensional location for each of a plurality of pixels of the synthetic image of the object. The method includes mapping, by the computing system using a machine-learned correspondence network, the three-dimensional location of each pixel to a two-dimensional coordinate in a two-dimensional canonical coordinate space. The method includes retrieving, by the computing system, a texture value from a set of texture data for each pixel of the synthetic image based on the two-dimensional coordinate for such pixel in the two-dimensional canonical coordinate space. The method includes rendering, by the computing system, the synthetic image of the object using the retrieved texture values for the plurality of pixels.

Another example aspect of the present disclosure is directed to computer system configured to perform operations. The operations include obtaining, by the computing system, data descriptive of a pose from which to render a synthetic image of an object. The operations include generating, by the computing system using an image generation model, a three-dimensional location for each of a plurality of pixels of the synthetic image of the object. The operations include mapping, by the computing system using a machine-learned correspondence network, the three-dimensional location of each pixel to a two-dimensional coordinate in a two-dimensional canonical coordinate space. The operations include retrieving, by the computing system, a texture value from a set of texture data for each pixel of the synthetic image based on the two-dimensional coordinate for such pixel in the two-dimensional canonical coordinate space. The operations include rendering, by the computing system, the synthetic image of the object using the retrieved texture values for the plurality of pixels.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 depicts a block diagram of an example framework for performing image synthesis according to example embodiments of the present disclosure.

FIG. 2 depicts a block diagram of an example framework for generating texture data according to example embodiments of the present disclosure.

FIG. 3 depicts a block diagram of an example framework for generating texture data according to example embodiments of the present disclosure.

FIG. 4 depicts a graphical diagram of an example nearest neighbor interpolation approach according to example embodiments of the present disclosure.

FIG. 5 depicts a flow chart diagram of an example method for generating texture data according to example embodiments of the present disclosure.

FIG. 6 depicts a flow chart diagram of an example method for performing image synthesis according to example embodiments of the present disclosure.

FIG. 7A depicts a block diagram of an example computing system according to example embodiments of the present disclosure.

FIG. 7B depicts a block diagram of an example computing device according to example embodiments of the present disclosure.

FIG. 7C depicts a block diagram of an example computing device according to example embodiments of the present disclosure.

Reference numerals that are repeated across plural figures are intended to identify the same features in various implementations.

### DETAILED DESCRIPTION

### Overview

Example aspects of the present disclosure are directed towards systems and methods for learning three-dimensional representations from one or more images (e.g., a single view) of one or more objects. One example application of the present technique is to generate textures for a synthetic image of an object. In particular, the proposed systems can train a machine-learned correspondence network to convert three-dimensional locations associated with pixels of images that depict the object into a two-dimensional canonical coordinate space. The trained correspondence network can then be used to map texture values from ground truth or synthetic images of the object into the two-dimensional canonical coordinate space, thereby creating a set of texture data expressed within the two-dimensional space. Then, when a new synthetic image is generated from a specified pose, the three-dimensional locations in the new image can also be mapped into the two-dimensional canonical coordinate space, so as to enable texture values to be retrieved and applied to the pixels of the new synthetic image. Furthermore, the computing system can allow a user to edit the set of texture data, thereby enabling texture edits and the transfer of textures across objects.

More particularly, in some implementations, an initial step can include obtaining one or more input images that depict an object. In some implementations, the image(s) can include only a single view or depiction of the object. In addition or alternatively, the image(s) can be “in-the-wild” images, which refers to images that are not taken in ideal conditions. For example, “in-the-wild” images can include images captured using standard consumer-grade cameras in non-studio lighting conditions.

A computing system can generate a set of texture data for the object based on the one or more input images. For example, the process of generating the texture data can begin with obtaining an image generation model. As one example, the image generation model can be a NeRF model, such as a tri-plane and GLO-based conditional NeRF.

The computing system can train the image generation model using the input image(s), resulting in the ability of the image generation model to generate synthetic images of the object from different poses. With the trained model, one or more views of the object can be produced from various poses. A set of three-dimensional points can be associated with each of the one or more views.

The computing system can then train a correspondence network based on the generated view(s) of the object. Specifically, this correspondence network learns to map from three-dimensional space to a two-dimensional canonical coordinate space based on the view(s) of the object.

The trained correspondence network can then be used to extract the set of texture data from the views and/or the input images. For example, extracting the texture data can include, for each pixel in one of the images, mapping the corresponding three-dimensional location into the two-dimensional space and then storing the texture data (e.g., RGB values) at the corresponding location in the two-dimensional space. Thus, the texture data can be derived from real-world and/or synthetic images of the object and can be expressed in the two-dimensional canonical coordinate space.

At inference time, the computing system can receive pose data that specifies a desired pose for a new synthetic image of the object. The computing system can use the image generation model to generate a set of three-dimensional pixel locations for pixels of the new synthetic image.

The 3D locations for the pixels of the new synthetic image can then be mapped to the two-dimensional canonical coordinate space using the correspondence network. The texture values at the corresponding locations in the two-dimensional canonical coordinate space can be retrieved and applied to the pixels of the synthetic image.

In some implementations, texture retrieval, which is based on the 2D coordinate for each pixel, can incorporate a nearest neighbor interpolation over multiple texture values, and/or could involve querying a K-d tree, depending on the structure of the texture data. This allows for efficient lookup and smoother textures which demonstrate fewer “holes”.

In some implementations, the proposed system also offers the potential for user interaction. In particular, the generated set of texture data can be editable by a user, thus allowing users to alter the appearance of the synthesized images. This enables text editing and/or transfer use cases.

Thus, the proposed techniques represent an innovative and flexible approach to image synthesis that enhances the quality of generated images and offers a greater level of control to the user. One key insight of the present disclosure is that by disentangling texture and geometry using the 3D surface points of objects to learn a dense correspondence mapping via a 2D canonical coordinate space, the computing system can extract a texture for each object.

Then, by using the learned correspondences to map the pixels from the input image of the object onto the texture, the computing system can preserve high-frequency details. Specifically, copying the input image pixels onto the texture accurately allows near perfect reconstruction while preserving high-fidelity multi-view consistent representation with high-frequency details, thereby enabling challenging tasks such as texture transfer, texture editing and high-fidelity 3D reconstruction even at large megapixel resolutions.

The proposed systems and method can perform single-view 3D reconstruction with no constraints on resolution by inverting the image into a latent table without requiring PTI or model fine-tuning. Thus, some example implementations can take a single-view image and its approximate camera pose to map the pixels onto a texture. Then, to render the object from a different view, the computing system can extract the 3D surface points from the trained NeRF and use the dense correspondences to obtain the color for each pixel from the mapped canonical texture. Optionally, the proposed systems can take texture edits and transfer textures across objects.

Thus, the present disclosure provides both a framework for effectively mapping the pixels from an in-the-wild single-view image onto a texture to enable high-fidelity 3D consistent representations preserving high-frequency details; and also a method for extracting canonical textures from single-view images enabling tasks such as texture editing and texture transfer for NeRFs.

The systems and methods of the present disclosure provide a number of technical effects and benefits. As one example technical effect and benefit, the proposed techniques employ a unique approach for generating high-fidelity and editable synthetic images of objects independent of their poses. Technically, the proposed techniques exploit machine learning methods to map three-dimensional pixel locations into a unified two-dimensional canonical coordinate space. This mapping enables texture transfer and texture editing without requiring meshes with shared topology.

In addition, another example technical effect and benefit of the present disclosure is the procedure for generating the texture data set. This process utilizes advanced image generation models, trained on input images of the object. It generates varied views of the object, which are subsequently used to train a correspondence network, responsible for extracting texture data. This feature has demonstrated effectiveness even at large megapixel resolutions. As another example technical effect and benefit is the provided flexibility in texture retrieval, promising efficient and high-performance image synthesis.

These technical effects improve the quality of rendered computer graphics and also provide new avenues for customization and interaction in practical applications such as virtual reality, gaming, and digital content creation.

With reference now to the Figures, example embodiments of the present disclosure will be discussed in further detail.

### Example Image Synthesis Techniques

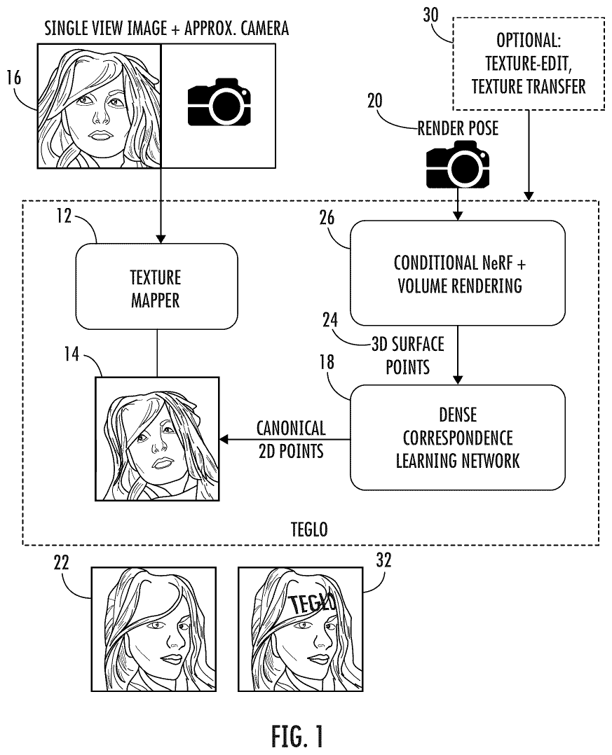

Example non-limiting implementations of the present disclosure are now described. Given a collection of single-view in-the-wild images of objects and their approximate camera poses, some example implementations aim to learn a textured 3D representation of the data. FIG. 1 provides a higher-level overview of the proposed framework.

As shown in FIG. 1, a first step can include the generation, by a texture mapping system 12, of texture data 14 from one or more input images 16 of the object. The input images 16 could be obtained from various sources, including digital photographs, 3D scans, or even computer-generated models.

In some implementations, the texture mapping system 12 can operate as follows: An image generation model 26 can be obtained. This could be a model based on Neural Radiance Fields (NeRF), a Generative Adversarial Network (GAN), or other types of machine learning model suitable for image generation tasks. The image generation model 26 could be a pre-existing model or one that has been specifically designed for the task at hand.

Next, the image generation model 26 is trained using the input image(s) 16. This could be done using standard machine learning techniques such as backpropagation and stochastic gradient descent. During this process, the image generation model 26 learns to generate synthetic images of the object based on the input image(s) 16.

Using the trained image generation model 26, the texture mapping system 12 generates views of the object from various poses. Each of these views is associated with a set of three-dimensional points. The poses could be predefined or randomly generated, and the 3D points could be generated as an output of the image generation model or based on an analysis of an output of the image generation model.

Following this, a correspondence network 18 is trained. This network 18 is used to map from the three-dimensional space to the two-dimensional canonical coordinate space. This could be achieved using a convolutional neural network (CNN), a fully connected neural network, or other types of machine learning model suitable for mapping tasks.

The texture mapping system 12 then uses the trained correspondence network 18 to extract the texture data 14 from the views and/or the input images 16. This texture data 14 is expressed in the two-dimensional canonical coordinate space.

Next, to generate a new image of the object, a computing system obtains data descriptive of a pose 20 from which to render a synthetic image 22 of the object. This could be based on user input, a predefined pose, or a pose randomly generated by the system.

The computing system then generates a three-dimensional location 24 for each pixel of the synthetic image 22 using the image generation model 26. This could involve ray tracing, volume rendering, and/or a similar 3D rendering technique.

Next, the system maps each pixel's 3D location 24 to a 2D coordinate in the canonical coordinate space using the correspondence network 18.

The system retrieves a texture value from the set of texture data 14 for each pixel based on its 2D coordinate. This could involve looking up the texture value in a database or array, or using an interpolation algorithm to calculate texture values for non-integer coordinates.

Finally, the synthetic image 22 of the object is rendered using the retrieved texture values for each pixel. This could involve a rasterization process, where each pixel is colored based on its associated texture value.

In some implementations, texture edits 30 can be provided. These edits 30 can adjust the texture data 14. This can result in a synthetic image 32 having an edited texture.

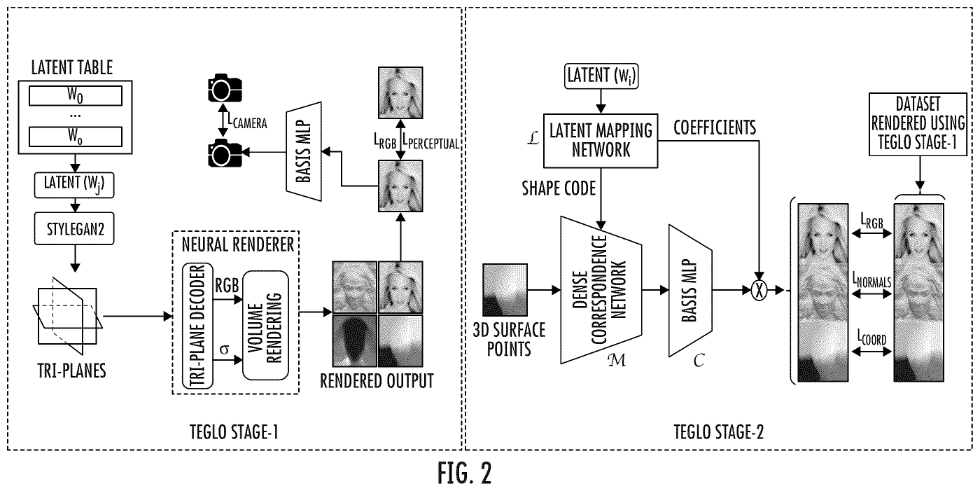

Some example implementations can include two stages for generation of the texture data: Stage-1: 3D representation learning; and Stage-2: dense correspondence learning. In particular, referring now to FIG. 2, in some implementations, Stage-1 can include the use of an image generation model (e.g., a conditional NeRF leveraging a Tri-Plane representation and an auto-decoder training regime based on generative latent optimization (GLO)) for 3D reconstruction of the image collection.

Stage-2 can use a dataset rendered using Stage-1 that includes the geometry from one or more (e.g., 5) views of an object and the optimized latent code. Stage-2 can also use the 3D surface points from the rendered dataset to learn dense pixel-level correspondences via a 2D canonical coordinate space.

Then, the inference stage (illustrated in FIG. 1 but not FIG. 2) can use the learned dense correspondences to map the image pixels from the single-view input image onto a texture extracted from Stage-2. As a result, some example implementations effectively preserve high frequency details at an unprecedented level of accuracy even at large megapixel resolutions. Another benefit is that the proposed techniques disentangle texture and geometry, thereby enabling texture transfer, texture editing, and single view 3D reconstruction without requiring fine-tuning or PTI.

### Example Techniques for Stage-1: 3D Representation

Example Formulation: Denote the single-view image collection ( [symbol] ) with class specific objects as {o₀, o₁, . . . , oₙ}∈ [symbol] . For learning 3D representations, example implementations of the present disclosure employs a generative latent optimization (GLO) based auto-decoder training, where NeRF is conditioned on an image specific latent code {w₀, w₁, . . . , wₙ}∈ [symbol] ^{D} to effectively reconstruct the image without requiring a discriminator.

Example Network Architecture: The NeRF model [symbol] is represented by Stage-1 in FIG. 2. The model [symbol] passes the input conditioning latent wᵢ to a set of CNN-based synthesis layers whose output feature maps are used to construct a k-channel tri-plane. The sampled points on each ray are used to extract the tri-plane features and aggregate the k-channel features. Then the tri-plane decoder MLP outputs the scalar density—and color which are alpha-composited by volume rendering to obtain the RGB image. Volume rendering along camera ray r(t)=0+td is:

$${𝒞}_{NeRF} ( r , w ) = {\int }_{{b}_{n}}^{{b}_{f}} T ( t , w ) σ ( r ( t ) , w ) c ( r ( t ) , d , w ) dt \qquad ( 1 )$$

$$where$$

$$T ( t , w ) = exp ( - {\int }_{{b}_{n}}^{{b}_{f}} σ ( r ( s ) , w ) ) ds$$

Here, the radiance values can be replaced with the depth d(x) or pixel opacity to obtain the surface depth. During inference, the surface depth map and 2D pixel coordinates can be used to obtain the 3D surface points via back-projection. The surface normals can be computed as the first derivative of the density σ with respect to the input as follows:

$$\hat{n} ( r , w ) = - {\int }_{{b}_{n}}^{{b}_{f}} T ( t , w ) σ ( r ( t ) , w ) {∇}_{r ( t )} ( σ ( r ( t ) , w ) ) dt \qquad ( 2 )$$

$$n ( r , w ) = \frac{\hat{n} ( r , w )}{{‖ \hat{n} ( r , w ) ‖}_{2}}$$

Thus, from a forward processing use of the image generation model, an RGB image, surface depth map, 3D surface points and the surface normals of the object instance can be obtained.

Example Losses: [symbol] is trained by jointly reconstructing the image and simultaneously optimizing a latent (wᵢ). This enables the training loss to be enforced on individual pixels enabling training and inference at arbitrary image resolutions. As depicted in Stage-1 in FIG. 2, three losses can be minimized to train [symbol] : [symbol] ^{RGB} is the [symbol] ₁ reconstruction loss between the pixels from the rendered image and the corresponding pixels from the ground truth image for the object (or). The [symbol] _{Perceptual} loss is the LPIPS (Learned Perceptual Image Patch Similarity) loss between rendered image and the ground truth image view. The camera is the camera prediction [symbol] ₁ loss between the output of the light-weight camera encoder and the ground-truth camera parameters for the camera pose in order to learn 3D consistent representation of the object (oᵢ∈ [symbol] ).

$${ℒ}_{𝒩} = {ℒ}_{RGB} + {ℒ}_{Perceptual} + {ℒ}_{Camera} \qquad ( 3 )$$

To train [symbol] , some example implementations use the single-view image dataset and the approximate pose for each oᵢ∈ [symbol] . Some example implementations train the model for 500K steps using the Adam optimizer on 8 NVIDIA V100 (16 GB) taking 36 hours to complete.

Example Implementation Details: In some implementations, [symbol] uses a GLO-based auto-decoder training paradigm which jointly optimizes a latent representation and reconstructs the image enabling arbitrary resolution synthesis—even at large megapixel resolutions—without the constraints of a discriminator. Hence, [symbol] enables 3D representations with geometric fidelity while also benefiting from an efficient tri-plane based representation.

Since [symbol] optimizes a latent representation of an object to reconstruct it, the generator does not require camera pose conditioning and simply using a light-weight camera predictor network and training with a camera prediction loss ( [symbol] _{camera}) is sufficient to learn 3D consistent representations.

### Example Techniques for Stage 2: Dense Correspondences

Example Formulation: Some example implementations render a multi-view dataset (D) using N trained on single-view image collections for the task of texture representation. Denote each object eᵢ∈ [symbol] comprising of five views: eᵢ={v_{f},vₗ,vᵣ,vₜ,v_{b}} where v denotes the view, and the sub-scripts (j for all vⱼ) denote frontal, left, right, top and bottom poses respectively. In [symbol] , each view vⱼ∈eᵤ includes the depth map (\hat{d}ⱼ), RGB image (\hat{r}ⱼ), surface normals (ŝⱼ), 3D surface points (\hat{p}ⱼ), and the optimized latent, wᵢ, which is identical for views of eᵢ as it is independent of camera pose. For Stage 2, some example implementations use {{\hat{r}ⱼ,ŝⱼ,\hat{p}ⱼ;}∈vⱼ,wᵢ}∈eᵢ}.

Learning dense pixel-level correspondences across multiple views of an object is the task of locating the same 3D coordinate point in a canonical coordinate space. Some example implementations aim to learn dense correspondences using the 3D surface points extracted from [symbol] by back-projecting the depth (\hat{d}ⱼ) and pixel coordinates. Some example implementations leverage a dense correspondence learning network in Stage-2 trained in an unsupervised manner learning an aligned canonical coordinate space to locate the same 3D surface point across different views (vⱼ) of the same object (eᵢ).

Example network architecture: Stage-2 is represented in FIG. 2. The architecture includes a latent mapping network ( [symbol] ), a dense correspondence network ( [symbol] ) and a basis network ( [symbol] )—all of which in some examples can be MLP networks. The 3D surface points (\hat{p}ⱼ) from vⱼ∈eᵢ) are mapped to a 2D canonical coordinate space conditioned on a shape code mapped from the optimized latent wᵢ for eᵢ. Some example implementations use a Lipschitz regularization for each MLP layer in the dense correspondence network ( [symbol] ). The latent mapping network ( [symbol] ) is a set of MLP layers that takes the wᵢ-latent for eᵢ as input and predicts a shape-code for conditioning the dense correspondence network [symbol] , an coefficients for the deformed basis. If the input is allowed to be represented as a weighted sum of basis images, i.e., to obtain a deformed basis before decomposition, then the 2D canonical coordinate space will be aligned. The basis network ( [symbol] ) uses the predicted coefficients to decompose the deformed coordinate points. Thus, [symbol] maps the 3D surface points to an aligned 2D canonical coordinate space, enabling the learning of dense correspondences using the pⱼ∈ [symbol] extracted from [symbol] . Next, the basis network takes the 2D canonical coordinates as input to predict the deformed basis [symbol] Then, [symbol] is weighted with the predicted coefficients to decompose the basis into the 3D surface points (pⱼ), surface normals (sⱼ) and color (rⱼ).

Example Losses: Stage-2 is trained using three [symbol] ₂ reconstruction losses: the RGB loss between the rendered RGB image \hat{r}ⱼ and the predicted RGB image \hat{r}ⱼ; the [symbol] _{Normals} loss between the rendered surface normals ŝⱼ and the predicted surface normals sⱼ; [symbol] _{Coord} loss between the extracted 3D surface points \hat{p}ⱼ and the predicted 3D surface points pⱼ. Hence, one example total training loss for Stage-2 is:

$${ℒ}_{Stage 2} = {ℒ}_{RGB} + {ℒ}_{Normals} + {ℒ}_{Coord} \qquad ( 4 )$$

To train Stage-2, some example implementations use the rendered dataset [symbol] consisting of 1000 objects with five views per object and the optimized latent for each identity. The networks can be trained using [symbol] _{Stage2} loss for 1000 epochs using the Adam optimizer to learn dense correspondences across eᵢ∈ [symbol] .

Example implementations details: Some example implementations use the optimized w-latent from [symbol] for learning the shape code and coefficients for Stage-2 because it represents the 3D geometry and appearance information for object (eᵢ) independent of camera pose. Using a Lipschitz regularization for every MLP layer in [symbol] suitably regularizes the network to deform the input surface points ŝⱼ. Interestingly, experiments show that simply reconstructing the 3D surface points instead of the color, surface points and surface normals also leads to learning reasonable dense pixel-level correspondences.

### Example Techniques for Inference

Example Techniques for extracting the texture: After training Stage-2, some example implementations can use the learned dense correspondences to extract a texture map for every object oᵢ∈ [symbol] . Some example implementations use the pose of the target image oᵢ to extract the 3D surface points from [symbol] and use it to map the image pixels to the 2D canonical coordinate space. Denote this as texture t_{GT}. Similarly, some example implementations use [symbol] to map the respective RGB values from {v_{f},vₗ,vᵣ,vₜ,v_{b}}∈eᵢ using the corresponding 3D surface points (sⱼ) from some or all of the five views to the 2D canonical coordinate space. Denote this as texture t_{views}. Thus, textures t_{GT} and t_{views} store a mapping of the canonical coordinate points and the corresponding RGB values.

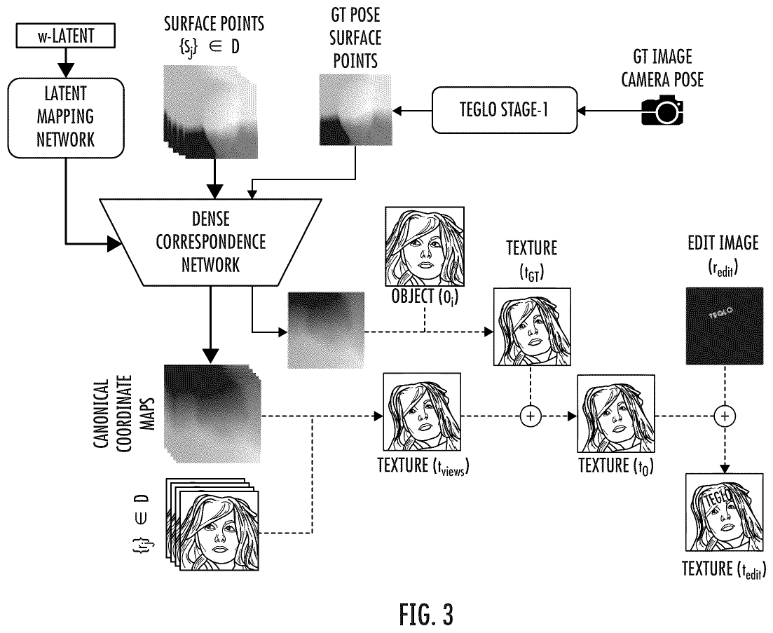

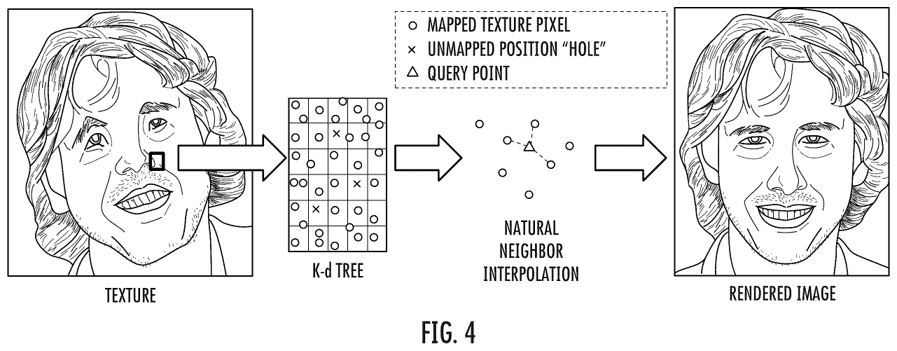

An example of this procedure is illustrated in FIG. 3. In FIG. 3, t_{O} represents the texture obtained by combining t_{GT} and t_{views}. Some example implementations store this mapping in a K-d tree which enables the computing system to index into the textures using accurate floating point indices to obtain the RGB values. The K-d tree allows querying with canonical coordinate points to extract multiple neighbors and enables example implementations of the present disclosure to be robust to sparse “holes” in the texture as depicted in FIG. 4.

Example novel view synthesis: For rendering novel views of oᵢ, some example implementations extract the 3D surface point for the pose from [symbol] and obtain the canonical coordinates from [symbol] . For each 2D canonical coordinate point cₖ, some example implementations query the K-d tree for three natural neighbors and obtain indices for the neighbors which are used to obtain the respective RGB values.

Natural Neighbor Interpolation (NNI) enables fast and robust reconstruction of a surface based on a Dirichlet tesselation—unique for every set of query points—to provide an unambiguous interpolation result. Some example implementations simplify the natural neighbor interpolation (NNI) based only on the distances of the points cₖ in the 2D canonical coordinate space to obtain the RGB values from the stored texture. The robust and unambiguous interpolation enables example implementations of the present disclosure to effectively map the ground-truth image pixels from the input dataset [symbol] onto the geometry for novel view synthesis.

To extract the Surface Field [symbol] , some example implementations render eₜ from five camera poses causing potential camera pose biases that may lead to sparse “holes” in the texture. The formulation used in some example implementations of the present disclosure uses the K-d tree and NNI to interpolate and index into textures with sparse “holes”. In FIG. 4, each cell in the 5×6 grid represents a discrete pixel in the texture space and the dot represents a canonical coordinate point. There are three issues that may arise:
1. The canonical coordinate points may not be aligned to the pixel centers and storing them in the discretized texture space may lead to imprecision.
2. There may be multiple canonical coordinates mapped to a discrete integral pixel wherein some coordinates may need to be dropped for an unambiguous texture indexing—leading to loss of information.
3. Some pixels may not be mapped to by any canonical coordinates, creating a “hole” in discretized space. This is represented by “X” in the grid in FIG. 4.

Use of a K-d tree allows extracting multiple neighbors by querying with canonical coordinate points and also enables indexing the texture using floating point values. Hence, using a K-d tree to store the texture helps address (1) and (2). Further, using a K-d tree in conjunction with Natural Neighbor Interpolation (NNI) effectively addresses (3).

Example texture editing: Texture editing is represented by t_{Edit} in FIG. 3. Some example implementations create the edits on a blank image the same size as that of t_{O} and denote it as r_{edit}. The edit image r_{edit} is taken to be in the canonical coordinate space and hence directly indexed into the K-d tree to be overlaid on to. Note that some example implementations do not apply any constraint on the texture space represented and hence the texture may be visually aligned to a non-frontal canonical pose. The final texture with the edit t_{Edit} can be created by combining t_{O} and r_{edit}.

### Example Methods

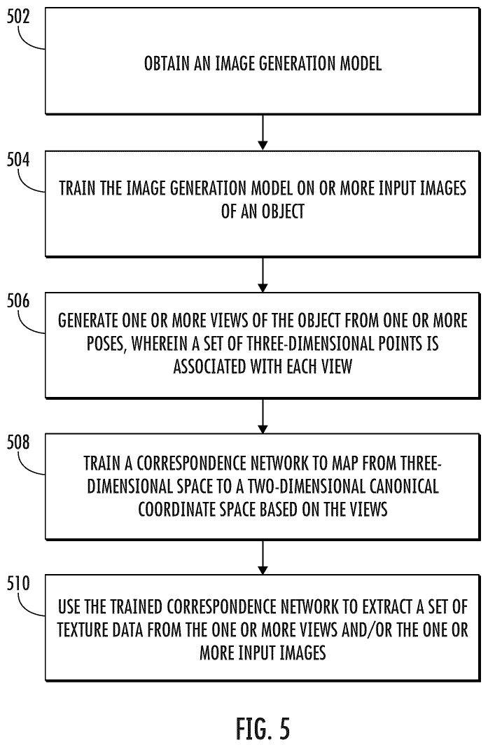

Refer now to FIG. 5, illustrating a flow chart that shows a detailed example embodiment of the computer-implemented method for generating a set of texture data to the present disclosure.

At the start of the process, in step 502, a computing system obtains an image generation model. This model might be pre-loaded within the system or might be loaded or downloaded based on the specific object or task at hand.

Next, in step 504, the computing system uses the obtained image generation model and trains it using one or more input images so that the model learns to generate synthetic images of the object. This training could involve a wide variety of machine learning or deep learning techniques to ensure that the model is capable of accurately generating synthetic images of the object.

In step 506, the computing system uses the trained image generation model to generate one or more views of the object from one or more poses. For each of these views, a set of three-dimensional points is associated. These views can include a variety of different perspectives on the object, allowing for a comprehensive understanding of its shape and appearance.

Following this, in step 508, the computing system trains a correspondence network. This network is trained to map from the three-dimensional space of the generated views to the two-dimensional canonical coordinate space. The training data for this process are the one or more views of the object that were generated in the previous step.

Finally, in step 510, the computing system uses the trained correspondence network to extract a set of texture data from the one or more views and/or the one or more input images. The set of texture data is expressed in the two-dimensional canonical coordinate space, enabling it to be readily used for the rendering of synthetic images of the object in the future.

It should be noted that the order of these steps can vary and some steps may be performed simultaneously or in a different sequence without departing from the spirit and scope of the invention. It should also be appreciated that the described method can be implemented as a computer program product including instructions that, when executed on a processor, carry out the steps of the method.

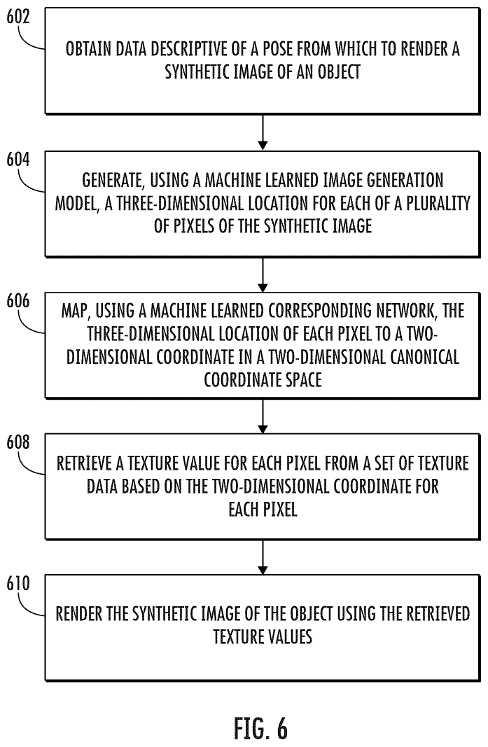

Referring now to FIG. 6, which provides a flow chart illustrating an example embodiment of the computer-implemented method for image synthesis, according to the present disclosure.

Step 602 denotes the initial process where the computing system obtains data descriptive of a pose from which to render a synthetic image of an object. This data might be supplied by the user or may be captured by a pose detection module.

In step 604, the computing system, using an image generation model (e.g., as described with reference to FIG. 5), generates a three-dimensional location for each of a plurality of pixels of the synthetic image of the object. This model could be a Neural Radiance Field (NeRF) model, a tri-plane representation, and/or another model trained using generative latent optimization.

Following that, in step 606, the computing system maps the three-dimensional location of each pixel to a two-dimensional coordinate in a two-dimensional canonical coordinate space. This can be performed using a machine-learned correspondence network (e.g., as described with reference to FIG. 5).

Then, at step 608, the computing system retrieves a texture value from a set of texture data for each pixel of the synthetic image. This retrieval is based on the two-dimensional coordinate for each pixel in the two-dimensional canonical coordinate space. The retrieval can include nearest neighbor interpolation over multiple texture values retrieved from a neighborhood in the two-dimensional canonical coordinate space and/or can include querying the texture data structured as a K-d.

The set of texture data could be editable and may have been edited by a user. Also, the system may generate the set of texture data from one or more input images of the object, as described with reference to FIG. 5.

Finally, in step 610, the computing system renders the synthetic image of the object using the retrieved texture values for the plurality of pixels. This culminates in the production of a synthetic image based on the input pose data.

It should be appreciated that the steps outlined above can be implemented in various orders, and some steps may be performed simultaneously or in a different order without departing from the scope of the invention. Further, it is understood that the described method can be implemented as a computer program product comprising instructions that, when executed on a processor, carry out the steps of the method.

### Example Devices and Systems

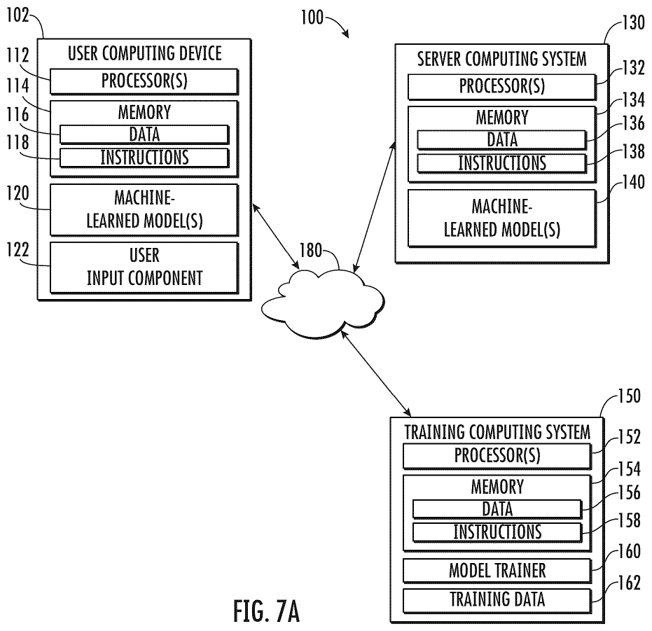

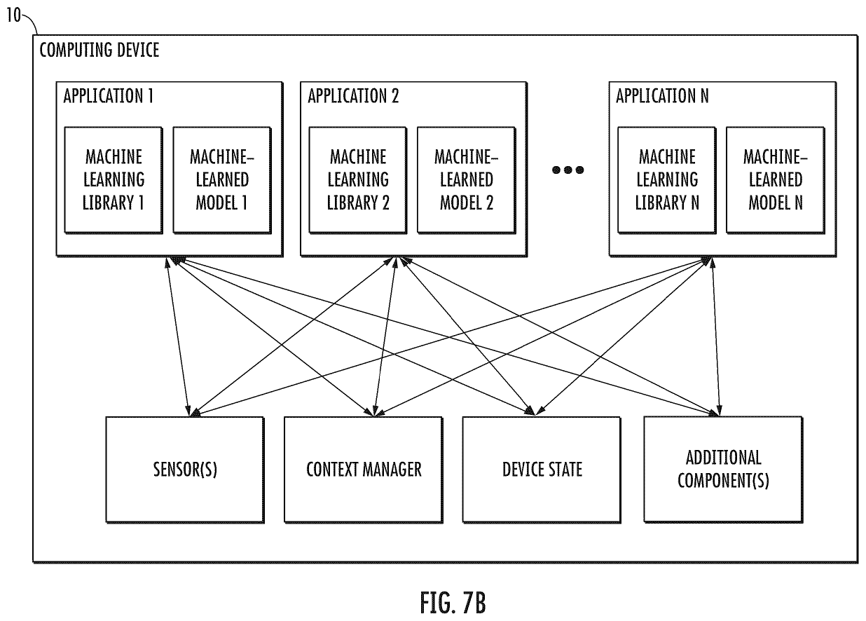

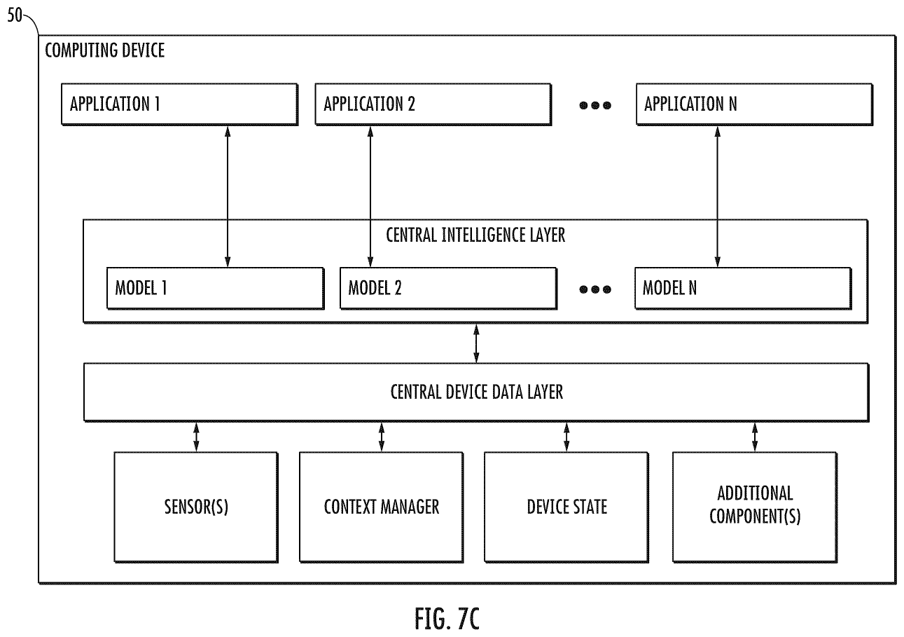

FIG. 7A depicts a block diagram of an example computing system 100 according to example embodiments of the present disclosure. The system 100 includes a user computing device 102, a server computing system 130, and a training computing system 150 that are communicatively coupled over a network 180.

The user computing device 102 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 102 includes one or more processors 112 and a memory 114. The one or more processors 112 can be any suitable processing device (e.g., a processor core, a microprocessor, an ASIC, an FPGA, a controller, a microcontroller, etc.) and can be one processor or a plurality of processors that are operatively connected. The memory 114 can include one or more non-transitory computer-readable storage media, such as RAM, ROM, EEPROM, EPROM, flash memory devices, magnetic disks, etc., and combinations thereof. The memory 114 can store data 116 and instructions 118 which are executed by the processor 112 to cause the user computing device 102 to perform operations.

In some implementations, the user computing device 102 can store or include one or more machine-learned models 120. For example, the machine-learned models 120 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models). Example machine-learned models 120 are discussed with reference to FIGS. 1-6.

In some implementations, the one or more machine-learned models 120 can be received from the server computing system 130 over network 180, stored in the user computing device memory 114, and then used or otherwise implemented by the one or more processors 112. In some implementations, the user computing device 102 can implement multiple parallel instances of a single machine-learned model 120.

Additionally or alternatively, one or more machine-learned models 140 can be included in or otherwise stored and implemented by the server computing system 130 that communicates with the user computing device 102 according to a client-server relationship. For example, the machine-learned models 140 can be implemented by the server computing system 140 as a portion of a web service (e.g., an image generation service). Thus, one or more models 120 can be stored and implemented at the user computing device 102 and/or one or more models 140 can be stored and implemented at the server computing system 130.

The user computing device 102 can also include one or more user input components 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 130 includes one or more processors 132 and a memory 134. The one or more processors 132 can be any suitable processing device (e.g., a processor core, a microprocessor, an ASIC, an FPGA, a controller, a microcontroller, etc.) and can be one processor or a plurality of processors that are operatively connected. The memory 134 can include one or more non-transitory computer-readable storage media, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more machine-learned models 140. For example, the models 140 can be or can otherwise include various machine-learned models. Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models). Example models 140 are discussed with reference to FIGS. 1-6.

The user computing device 102 and/or the server computing system 130 can train the models 120 and/or 140 via interaction with the training computing system 150 that is communicatively coupled over the network 180. The training computing system 150 can be separate from the server computing system 130 or can be a portion of the server computing system 130.

The training computing system 150 includes one or more processors 152 and a memory 154. The one or more processors 152 can be any suitable processing device (e.g., a processor core, a microprocessor, an ASIC, an FPGA, a controller, a microcontroller, etc.) and can be one processor or a plurality of processors that are operatively connected. The memory 154 can include one or more non-transitory computer-readable storage media, such as RAM, ROM, EEPROM, EPROM, flash memory devices, magnetic disks, etc., and combinations thereof. The memory 154 can store data 156 and instructions 158 which are executed by the processor 152 to cause the training computing system 150 to perform operations. In some implementations, the training computing system 150 includes or is otherwise implemented by one or more server computing devices.

The training computing system 150 can include a model trainer 160 that trains the machine-learned models 120 and/or 140 stored at the user computing device 102 and/or the server computing system 130 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

In some implementations, performing backwards propagation of errors can include performing truncated backpropagation through time. The model trainer 160 can perform a number of generalization techniques (e.g., weight decays, dropouts, etc.) to improve the generalization capability of the models being trained.

In particular, the model trainer 160 can train the machine-learned models 120 and/or 140 based on a set of training data 162. The training data 162 can include, for example, images selected, uploaded, or otherwise input by a user.

In some implementations, if the user has provided consent, the training examples can be provided by the user computing device 102. Thus, in such implementations, the model 120 provided to the user computing device 102 can be trained by the training computing system 150 on user-specific data received from the user computing device 102. In some instances, this process can be referred to as personalizing the model.

The model trainer 160 includes computer logic utilized to provide desired functionality. The model trainer 160 can be implemented in hardware, firmware, and/or software controlling a general purpose processor. For example, in some implementations, the model trainer 160 includes program files stored on a storage device, loaded into a memory and executed by one or more processors. In other implementations, the model trainer 160 includes one or more sets of computer-executable instructions that are stored in a tangible computer-readable storage medium such as RAM, hard disk, or optical or magnetic media.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

The computing system 100 can also include an Image Processing Unit (IPU) 170. The IPU 170 can be integrated into the user computing device 102, the server computing system 130, and/or the training computing system 150, or can be implemented as a standalone component. The IPU 170 can perform specific operations related to the processing of image data, including but not limited to, the generation of synthetic images of objects, the creation of views from different poses, and the extraction of texture data.

The IPU 170 can be operatively connected to the processors (112, 132, 152) and memory (114, 134, 154) of the respective systems. The IPU 170 can include one or more specialized processors or cores optimized for operations such as convolution, matrix multiplication, interpolation, and other operations commonly performed in the process of image generation, manipulation, and analysis. Furthermore, the IPU 170 can have access to dedicated memory or cache that provides fast and efficient storage and retrieval of image data, model parameters, and other related information.

The IPU 170 can work in conjunction with the machine-learned models 120, 140 and the model trainer 160. It can be used to accelerate the training and execution of these models, especially when dealing with large volumes of image data or complex models. The IPU 170 can also help in the generation of the synthetic images of the object, one or more views of the object from one or more poses, and the training of the correspondence network to map from three-dimensional space to the two-dimensional canonical coordinate space.

Moreover, the IPU 170 can help in the extraction of the set of texture data from the one or more views or the one or more input images. This extraction operation can be a computationally intensive process which can benefit greatly from the specific hardware acceleration provided by the IPU 170. Therefore, the inclusion of the IPU 170 can enhance the overall performance, efficiency and capability of the computing system in implementing the disclosed processes and methods.

FIG. 7A illustrates one example computing system that can be used to implement the present disclosure. Other computing systems can be used as well. For example, in some implementations, the user computing device 102 can include the model trainer 160 and the training dataset 162. In such implementations, the models 120 can be both trained and used locally at the user computing device 102. In some of such implementations, the user computing device 102 can implement the model trainer 160 to personalize the models 120 based on user-specific data.

FIG. 7B depicts a block diagram of an example computing device 10 that performs according to example embodiments of the present disclosure. The computing device 10 can be a user computing device or a server computing device.

The computing device 10 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 7B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 7C depicts a block diagram of an example computing device 50 that performs according to example embodiments of the present disclosure. The computing device 50 can be a user computing device or a server computing device.

The computing device 50 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 7C, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of the computing device 50.

The central intelligence layer can communicate with a central device data layer. The central device data layer can be a centralized repository of data for the computing device 50. As illustrated in FIG. 7C, the central device data layer can communicate with a number of other components of the computing device, such as, for example, one or more sensors, a context manager, a device state component, and/or additional components. In some implementations, the central device data layer can communicate with each device component using an API (e.g., a private API).

### ADDITIONAL DISCLOSURE

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

What is claimed is:

1. A computer-implemented method to perform image synthesis, the method comprising:
obtaining, by a computing system comprising one or more computing devices, data descriptive of a pose from which to render a synthetic image of an object;
generating, by the computing system using an image generation model, a three-dimensional location for each of a plurality of pixels of the synthetic image of the object;
mapping, by the computing system using a machine-learned correspondence network, the three-dimensional location of each pixel to a two-dimensional coordinate in a two-dimensional canonical coordinate space;
retrieving, by the computing system, a texture value from a set of texture data for each pixel of the synthetic image based on the two-dimensional coordinate for such pixel in the two-dimensional canonical coordinate space; and
rendering, by the computing system, the synthetic image of the object using the retrieved texture values for the plurality of pixels.

2. The computer-implemented method of claim 1, wherein the set of texture data is editable and has been edited by a user.

3. The computer-implemented method of claim 1, further comprising generating, by the computing system, the set of texture data from one or more input images of the object, wherein generating the set of texture data comprises:
obtaining, by the computing system, the image generation model;
training, by the computing system using the one or more input images, the image generation model to generate synthetic images of the object;
generating, by the computing system using the image generation model, one or more views of the object from one or more poses, wherein a set of three-dimensional points is associated with each of the one or more views;
training, by the computing system, the correspondence network to map from three-dimensional space to the two-dimensional canonical coordinate space based on the one or more views of the object; and
using, by the computing system, the trained correspondence network to extract the set of texture data from the one or more views or the one or more input images, wherein the set of texture data is expressed in the two-dimensional canonical coordinate space.

4. The computer-implemented method of claim 1, wherein the image generation model comprises a neural radiance field (NERF) model.

5. The computer-implemented method of claim 1, wherein the image generation model comprises a tri-plane representation.

6. The computer-implemented method of claim 1, wherein the image generation model is trained using generative latent optimization.

7. The computer-implemented method of claim 3, wherein:
generating, by the computing system using the image generation model, the one or more views of the object from one or more poses comprises generating, by the computing system using the image generation model, multiple views of the object from multiple poses;
training, by the computing system, the correspondence network to map from three-dimensional space to the two-dimensional canonical coordinate space based on the one or more views of the object comprises training, by the computing system, the correspondence network to map from three-dimensional space to the two-dimensional canonical coordinate space based on the multiple views of the object; and
using, by the computing system, the trained correspondence network to extract the set of texture data from the one or more views or the one or more input images comprises using, by the computing system, the trained correspondence network to extract the set of texture data from the multiple views.

8. The computer-implemented method of claim 7, wherein the multiple views comprise a frontal view, a left view, a right view, a top view, and a bottom view.

9. The computer-implemented method of claim 3, wherein using, by the computing system, the trained correspondence network to extract the set of texture data from the one or more views or the one or more input images comprises using, by the computing system, the trained correspondence network to extract the set of texture data from both the one or more views and the one or more input images.

10. The computer-implemented method of claim 1, wherein retrieving, by the computing system, the texture value from the set of texture data for each pixel of the synthetic image based on the two-dimensional coordinate for such pixel in the two-dimensional canonical coordinate space comprises performing a nearest neighbor interpolation over multiple texture values retrieved from a neighborhood in the two-dimensional canonical coordinate space.

11. The computer-implemented method of claim 1, wherein the set of texture data is structured as a K-d tree and wherein retrieving, by the computing system, the texture value from the set of texture data for each pixel of the synthetic image based on the two-dimensional coordinate for such pixel in the two-dimensional canonical coordinate space comprises querying the K-d tree.

12. A computer system configured to perform operations, the operations comprising:
obtaining, by the computing system, data descriptive of a pose from which to render a synthetic image of an object;
generating, by the computing system using an image generation model, a three-dimensional location for each of a plurality of pixels of the synthetic image of the object;
mapping, by the computing system using a machine-learned correspondence network, the three-dimensional location of each pixel to a two-dimensional coordinate in a two-dimensional canonical coordinate space;
retrieving, by the computing system, a texture value from a set of texture data for each pixel of the synthetic image based on the two-dimensional coordinate for such pixel in the two-dimensional canonical coordinate space; and
rendering, by the computing system, the synthetic image of the object using the retrieved texture values for the plurality of pixels.

13. The computer system of claim 12, wherein the set of texture data is editable and has been edited by a user.

14. The computer system of claim 12, further comprising generating, by the computing system, the set of texture data from one or more input images of the object, wherein generating the set of texture data comprises:
obtaining, by the computing system, the image generation model;
training, by the computing system using the one or more input images, the image generation model to generate synthetic images of the object;
generating, by the computing system using the image generation model, one or more views of the object from one or more poses, wherein a set of three-dimensional points is associated with each of the one or more views;
training, by the computing system, the correspondence network to map from three-dimensional space to the two-dimensional canonical coordinate space based on the one or more views of the object; and
using, by the computing system, the trained correspondence network to extract the set of texture data from the one or more views or the one or more input images, wherein the set of texture data is expressed in the two-dimensional canonical coordinate space.

15. The computer system of claim 12, wherein the image generation model comprises a neural radiance field (NERF) model.

16. The computer system of claim 12, wherein the image generation model comprises a tri-plane representation.

17. The computer system of claim 12, wherein the image generation model is trained using generative latent optimization.

18. The computer system of claim 14, wherein:
generating, by the computing system using the image generation model, the one or more views of the object from one or more poses comprises generating, by the computing system using the image generation model, multiple views of the object from multiple poses;
training, by the computing system, the correspondence network to map from three-dimensional space to the two-dimensional canonical coordinate space based on the one or more views of the object comprises training, by the computing system, the correspondence network to map from three-dimensional space to the two-dimensional canonical coordinate space based on the multiple views of the object; and
using, by the computing system, the trained correspondence network to extract the set of texture data from the one or more views or the one or more input images comprises using, by the computing system, the trained correspondence network to extract the set of texture data from the multiple views.

19. The computer system of claim 18, wherein the multiple views comprise a frontal view, a left view, a right view, a top view, and a bottom view.

20. The computer system of claim 14, wherein using, by the computing system, the trained correspondence network to extract the set of texture data from the one or more views or the one or more input images comprises using, by the computing system, the trained correspondence network to extract the set of texture data from both the one or more views and the one or more input images.
